(19) United States
(12) Patent Application Publication
(10) Pub. No.: US 2014/0028146 A1
(43) Pub. Date: Jan. 30, 2014

(54) Induction Motor and Railway Vehicle Using Induction Motor

(71) Applicant: Hitachi, Ltd., Tokyo (JP)

(72) Inventors: Shinji SUGIMOTO, Hitachinaka (JP); Akiyoshi KOMURA, Hitachi (JP); Mamoru KIMURA, Hitachinaka (JP); Seikichi MASUDA, Hitachi (JP); Masatoshi KOIKE, Naka-gun (JP); Mikio ENDO, Hitachinaka (JP)

(21) Appl. No.: 13/917,523

(22) Filed: Jun. 13, 2013

(30) Foreign Application Priority Data
Jul. 24, 2012 (JP) 2012-163471

(51) Int. Cl. H02K 1/26

(52) U.S. Cl. CPC H02K 1/265
USPC 310/216.069

(57) ABSTRACT

An induction motor includes: a stator and a rotor arranged so as to face the stator via a void, the rotor including conductor bars in a plurality of slots formed by a plurality of teeth arranged so as to extend in the circumferential direction of a rotatably held rotor core, wherein the circumferential width of distal end portions of the slots on the radially outside of the rotor core are narrowed by distal end portion of the teeth on the radially outside of the rotor core, and the teeth are each formed with a projection protruding in an arcuate shape from the distal end of the tooth on the radially outside of the rotor core toward the conductor bar in each of the slots.

### BACKGROUND OF THE INVENTION

1. Technical Field

The present invention relates to an induction motor and a railway vehicle using the induction motor and, more specifically, to a highly-efficient induction motor and a railway using the highly-efficient induction motor.

2. Description of the Related Art

In general, a cause of losses of an induction motor is roughly divided into a primary copper loss occurring when power is distributed to stator coils, a secondary copper loss caused by a current flowing by being guided by a conductor bar of a rotor, an iron loss occurring in a stator and an iron core of the rotor, and a mechanical loss and a stray loss caused by a rotation.

Among those losses described above, the loss included in the stray loss includes a harmonic secondary copper loss caused by a high-frequency current guided to a portion near a surface of the conductor bar of the rotor. The harmonic secondary copper loss accounts for a large percentage of the causes of the losses of the induction motor and, in addition, the percentage further increases due to the tendency of reduction of the losses due to other causes in recent years.

For such reasons, various methods of reduction of losses relating to the harmonic secondary copper loss are proposed. For example, in a rotor slot shape of induction motors disclosed in JP-A-9-224258, JP-A-08-140319, and JP-A-02-123951, a bridge is provided on the void side of the conductor bar of the rotor so as to provide the slot with a fully-closed slot shape. In addition, the harmonic secondary copper loss occurring in the rotor conductor bar is reduced by providing a space on the void side of the bridge.

Also, in a rotor slot shape of induction motors disclosed in JP-A-2011-87373 and JP-A-2011-87375, projections are provided on the void side of the conductor bars of the rotor so as to provide the slots with an opened slot shape. In addition, the harmonic secondary copper loss occurring in the rotor conductor bars is reduced by providing the spaces on the void side of the bridge.

In the rotor slot shape of an induction motor disclosed in JP-A-2007-295724, spaces is provided on the void side of the conductor bars of the rotor to reduce the harmonic secondary copper loss occurring in the rotor conductor bars.

However, the configurations described in JP-A-9-224258, JP-A-08-140319, and JP-A-02-123951 have a problem that since the slots have the fully-closed slot shape, a leak magnetic field at a bridge portion is increased, and hence the power factor thereof is lowered.

The configurations described in JP-A-2011-87373 and JP-A-2011-87375 have a problem that the leak magnetic field is increased, since the projections are present on the void side of the conductor bars of the rotor, the power factor is lowered in the same manner as JP-A-9-224258, JP-A-08-140319, and JP-A-02-123951.

In the configuration described in JP-A-2007-295724, since the bridge portion and the projections are not provided, the lowering of the power factor is small. However, since magnetic saturation at distal end portions of rotor teeth is increased, the leak magnetic field is increased, and hence a magnetic flux flows on the surfaces of the rotor conductor bars. Therefore, the harmonic secondary copper loss is increased.

A schematic drawing of a distal end portion 32 of a rotor tooth in the case of JP-A-2007-295724, will be illustrated in FIG. 13. In FIG. 13, a rotor core 7 includes cylindrical rotor yoke portion 30, and a plurality of rotor teeth 31 protruding radially outward from an outer peripheral surface of the rotor yoke portion 30 and extending in the axial direction along the outer peripheral surface of the rotor yoke portion 30. Rotor slots 6 for accommodating rotor conductor bars 13 are arranged in the circumferential direction between the rotor teeth 31.

Looking at the structure of the distal end portion 32 of each of the rotor teeth, a circumferential width d2 of the rotor conductor bar 13 on the radially outside of the rotor with respect to a circumferential width d1 of the rotor slot 6 on the radially outside of the rotor has a relationship of d2>d1. In other words, by employing a structure in which the width at the distal ends of the rotor slots 6 are reduced by the rotor teeth 31, the rotor conductor bars 13 are inhibited from flying out from the rotor slots 6 due to a centrifugal force.

In this structure, a portion where the width d1 at the distal end portion is increased to the width d2 of the rotor conductor bar 13 (hereinafter, referred to as an inhibiting portion) is formed by linear lines.

FIG. 13 illustrates a magnetic flux φ in this case. The magnetic flux φ flowing from the stator side to the rotor side during the rotation, which desirably reaches the rotor yoke portion 30 through the rotor teeth 31 as indicated by a magnetic flux φ, flows across an outer peripheral surfaces of the rotor conductor bars 13 partly as indicated by a magnetic flux φ1.

In the structure in JP-A-2007-295724 in which the inhibiting portions are formed of the linear lines, the leak magnetic field is increased because the magnetic saturation at the distal end portions of the rotor teeth is increased, so that magnetic fluxes flow on the surfaces of the rotor conductor bars, and hence the harmonic secondary copper loss is increased.

### SUMMARY OF THE INVENTION

It is an object of the invention to eliminate the above-described problems, and to provide a highly-efficient induction motor and a railway vehicle using the highly-efficient induction motor.

In view of such circumstances, there is provided an induction motor including: a stator and a rotor arranged so as to face the stator via a void, the rotor including conductor bars in a plurality of slots formed by a plurality of teeth arranged in the circumferential direction of a rotatably held rotor core, wherein the circumferential width of distal end portions of the slots on the radially outside of the rotor core are narrowed by distal end portions of the teeth on the radially outside of the rotor core, and the teeth are each formed with a projection protruding in an arcuate shape from the distal end of the tooth on the radially outside of the rotor core toward the conductor bar in each of the slots.

According to the invention, since the harmonic secondary copper loss of the induction motor may be reduced, increase in efficiency of the induction motor is achieved.

### BRIEF DESCRIPTION OF THE DRAWINGS

FIG. 1 is an axial cross-sectional view of an induction motor according to a mode of Example 1;

FIG. 2 is a cross-sectional view illustrating the induction motor according to the mode of Example 1;

FIG. 3 is an enlarged view illustrating a rotor slot portion of the induction motor according to the mode of Example 1;

FIG. 4 is a drawing illustrating a relationship between a length L and a radius of curvature R in a distal end portion of a rotor tooth;

FIG. 5 is a drawing illustrating the shape of an inhabiting portion when R/L=0 is established;

FIG. 6 is a drawing illustrating the shape of the inhabiting portion when R/L=0.5 is established;

FIG. 7 is a drawing illustrating the shape of the inhabiting portion when R/L=1 is established;

FIG. 8 is a drawing illustrating the shape of the inhabiting portion when R/L=2 is established;

FIG. 9 is a drawing illustrating a relationship between a curvature ratio (R/L) and respective copper losses with respect to the length L;

FIG. 10 is an enlarged view of the rotor slot portion of the induction motor according to a mode of Example 2;

FIG. 11 is an enlarged view of the rotor slot portion of the induction motor according to a mode of Example 3;

FIG. 12 is an enlarged view of the rotor slot portion of the induction motor according to a mode of Example 4;

FIG. 13 is an enlarged view of a rotor slot portion of an induction motor of the related art;

FIG. 14 is a perspective view of the induction motor 1 according to a mode of Example 5;

FIG. 15 is an enlarged view of the rotor slot portion of an open type rotor core 70;

FIG. 16 is an enlarged view of the rotor slot portion of a fully-closed type rotor core 71;

FIG. 17 is a perspective view of an induction motor 1 according to a mode of Example 6;

FIG. 18 is an enlarged view of the rotor slot portion of the induction motor according to a mode of Example 7; and

FIG. 19 is a block configuration drawing illustrating a railway vehicle on which the induction motor according to Example 8 is mounted.

### DESCRIPTION OF THE PREFERRED EMBODIMENTS

Referring now to the drawings, examples of the invention will be described.

### Example 1

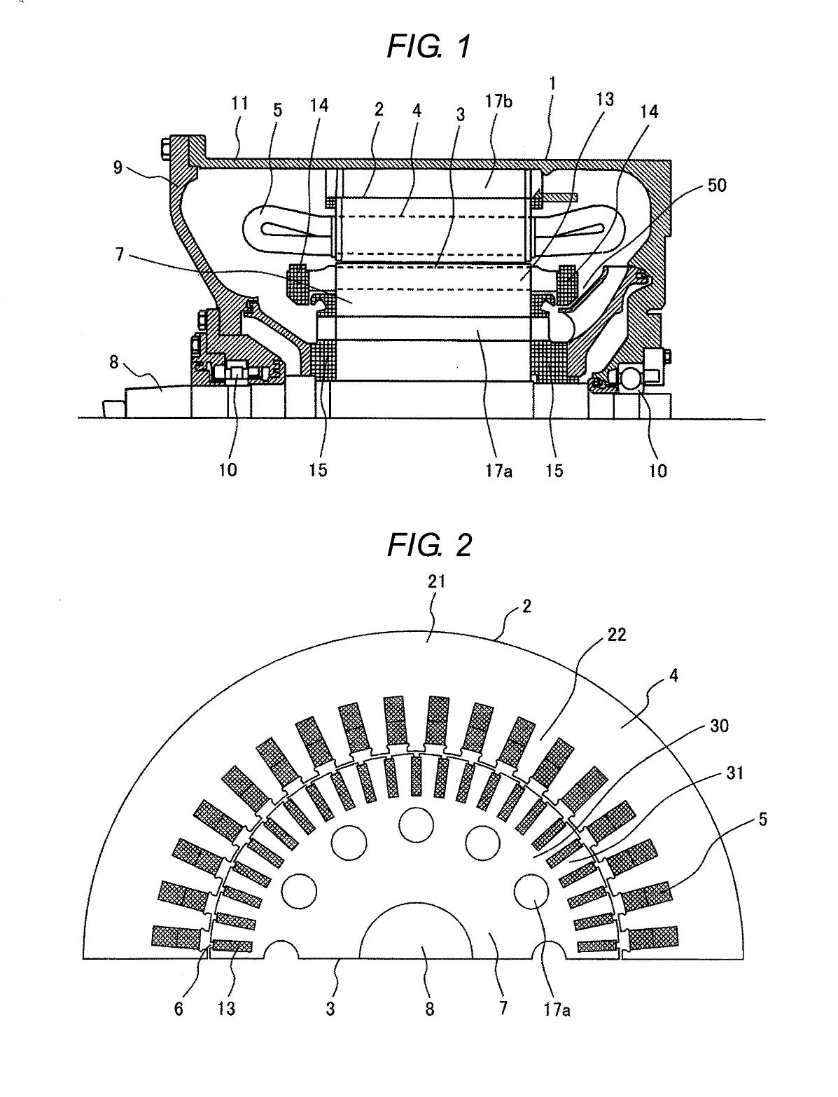

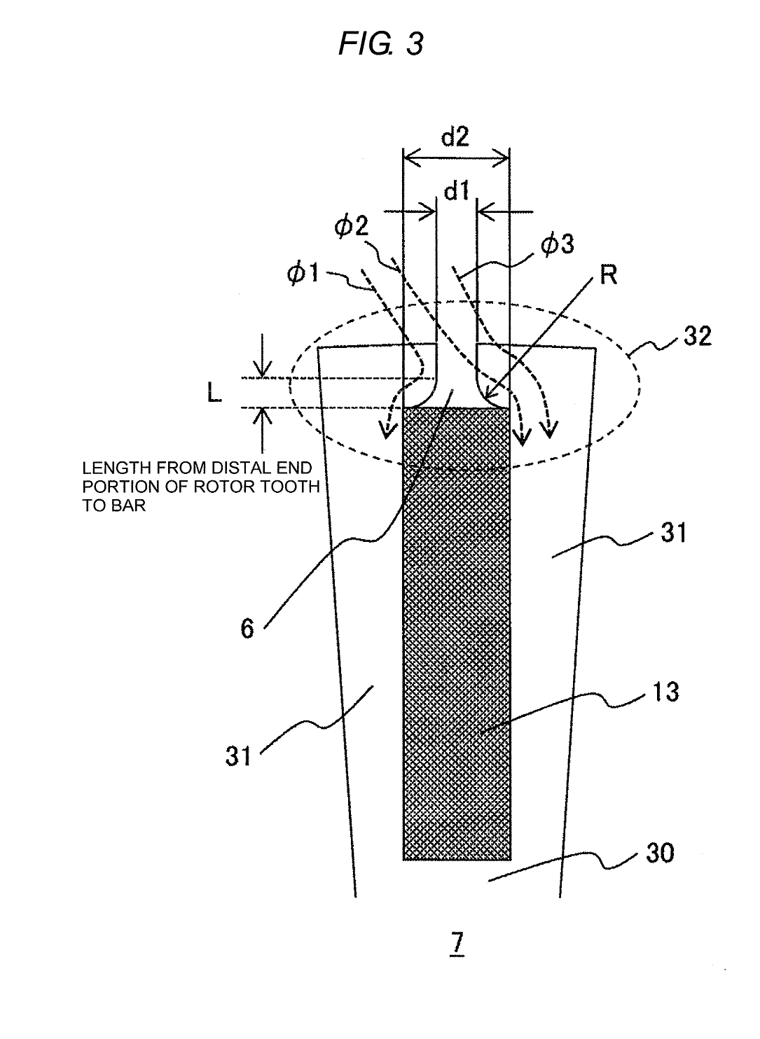

Referring now to FIG. 1, FIG. 2, and FIG. 3, Example 1 of the invention will be described. FIG. 1 is an axial cross-sectional view of an induction motor 1 according to a mode of Example 1 of the invention. A stator 2 of the induction motor 1 includes a stator core 4, a multiphase stator coil 5 wound around the stator core 4, and a housing 11 configured to hold the stator core 4 on an inner peripheral surface thereof.

A rotor 3 includes a rotor core 7, end plates 15, a shaft 8, and a bearing 10, and the bearing 10 is rotatably held. The bearing 10 is supported by an end bracket 9, and the end bracket 9 is fixed to the housing 11. The stator core 4 is inhibited from moving in the axial direction by the end plates 15 at both axial end portions thereof.

A plurality of rotor slots for inserting rotor conductor bars 13 formed of a conductor are provided on the rotor core 7 of the rotor 3. The rotor conductor bars 13 are connected to end rings 14 at both axial end portions of the rotor.

An inner fan 50 configured to ventilate the internal air is connected to the end plates 15. Also, a hole 17a for ventilating the internal air communicating with an inner peripheral portion of the rotor core 7 in the axial direction is formed to ventilate the internal air. A duct 17b for ventilating the internal air is formed on the outer peripheral side of the stator 2, and wind generated by the inner fan 50 is ventilated therethrough.

FIG. 2 is an axial cross-sectional view of the induction motor 1 according to the mode of Example 1 of the invention, and illustration of the housing is omitted. In FIG. 2, the induction motor 1 includes the stator 2 and the rotor 3.

The stator 2 is composed of the stator core 4 and the stator coil 5. The stator coil 5 is wound around the stator core 4. The stator core 4 includes a cylindrical stator yoke portion 21, and a plurality of stator teeth 22 protruding radially inward from an inner peripheral, surface of the stator yoke portion 21 and extending in the axial direction along the inner peripheral surface of the stator yoke portion 21. The stator teeth 22 are arranged equidistantly in the circumferential direction along the inner peripheral surface of the stator yoke portion 21.

In the rotor 3, the rotor core 7 formed by laminating a plurality of electromagnetic steel plates, and the rotor conductor bars 13 are inserted into a plurality of rotor slots 6 provided on the rotor core 7.

The rotor core 7 includes a cylindrical rotor yoke portion 30, and a plurality of rotor teeth 31 protruding radially outward from an outer peripheral surface of the rotor yoke portion 30 and extending in the axial direction along the outer peripheral surface of the rotor yoke portion 30. The rotor teeth 31 are arranged equidistantly in the circumferential direction along the outer peripheral surface of the rotor yoke portion 30. Also, the plurality of rotor slots 6 for accommodating the rotor conductor bars 13 are arranged equidistantly in the circumferential direction between the rotor teeth 31.

The rotor core 7 has a structure formed with a hole which allows passage of the shaft 8 by punching, and the rotor 3 is configured by laminating the electromagnetic steel plates formed with the hole which allows passage of the shaft 8 by punching, and inserting the shaft 8 into the through hole which allows the passage of the shaft 8. In the cross-section of FIG. 2, the holes 17a for ventilating the internal air are formed in the axial direction of the rotor core 7.

The rotor 3 is configured to rotate clockwise and counterclockwise, and to be operated as a motor.

FIG. 3 illustrates an enlarged view of the slot portion and the tooth of the rotor according to the mode of Example 1 illustrated in FIG. 2. A characteristic point here is a point where the shape of the inhibiting portion of a distal end portion 32 of the rotor tooth is formed into an arcuate shape as projecting portions directed toward the rotor conductor bar 13. An arc of the projecting portions in FIG. 3 are indicated by R. The reference sign R denotes a radius of curvature.

With this shape, magnetic saturation of the distal end portion 32 of the rotor tooth is alleviated, and a magnetic flux flow as indicated by the arrows φ1, 2, and 3. Therefore, a harmonic secondary copper loss occurring on a surface of a rotor conductor bar 13 on the stator side is reduced, and hence the efficiency may be improved.

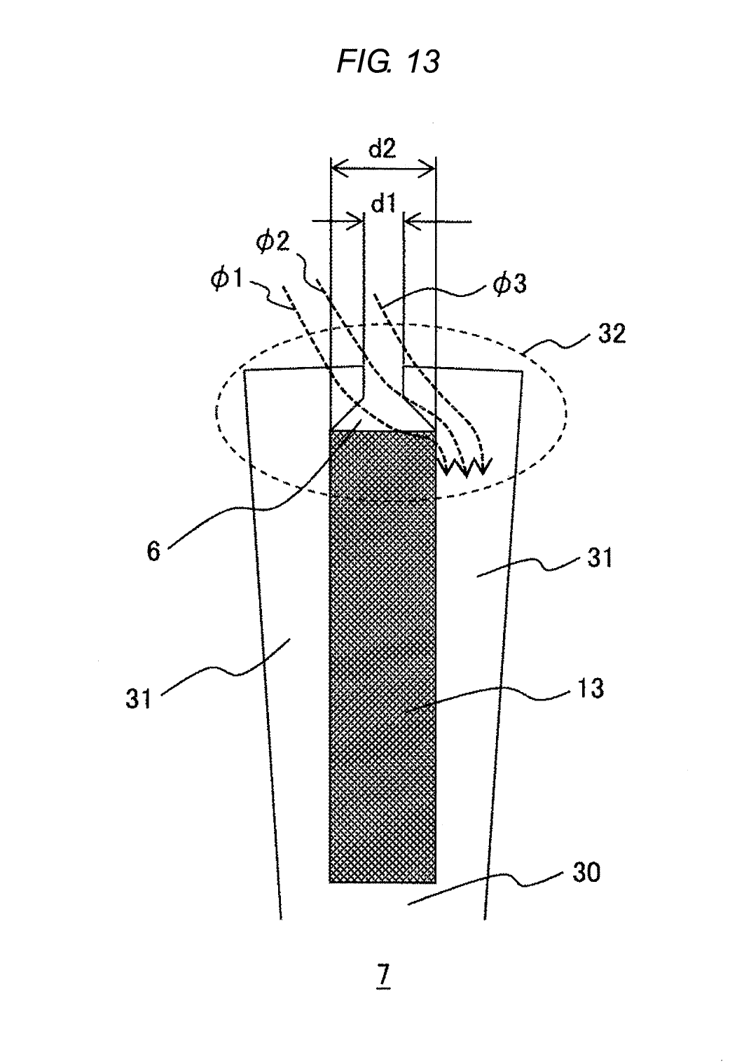

In an enlarged view of the rotor slot of the related art illustrated in FIG. 13, a magnetic flux flow φ pass across a surface of the rotor conductor bar 13 in a slot as indicated by arrow φ1 at a distal end portion 32 of the rotor tooth of the related art. In contrast, in the enlarged view of the slot of Example 1 of the invention illustrated in FIG. 3, the magnetic flux flow φ do not pass across a surface of the rotor conductor bar 13 in the slot at the distal end portion 32 of a rotor tooth.

Furthermore, in the invention, by determining the ratio between a length L in FIG. 3 and the projecting portion formed in the arcuate shape toward the rotor conductor bar 13 adequately, the harmonic secondary copper loss occurring on the surface of the rotor conductor bar 13 on the stator side is reduced, and the efficiency is improved.

The length L in FIG. 3 is a length from the distal end portion of the rotor tooth and the conductor bar and, the length L is defined by widths d1 and d2 in the same manner as FIG. 13 can be defined as a distance in the circumferential direction when the width d1 at the distal end portion is increased to the width d2. The width d1 corresponds to the width d1 at the distal end portion of the rotor slot 6 on the radially outside of the rotor core and the width d2 corresponds to the width d2 at the distal end portion of the rotor conductor bar 13 in the circumferential direction. On the other hand, the projecting portion formed in the arcuate shape toward the rotor conductor bar 13 is defined as the radius of curvature R.

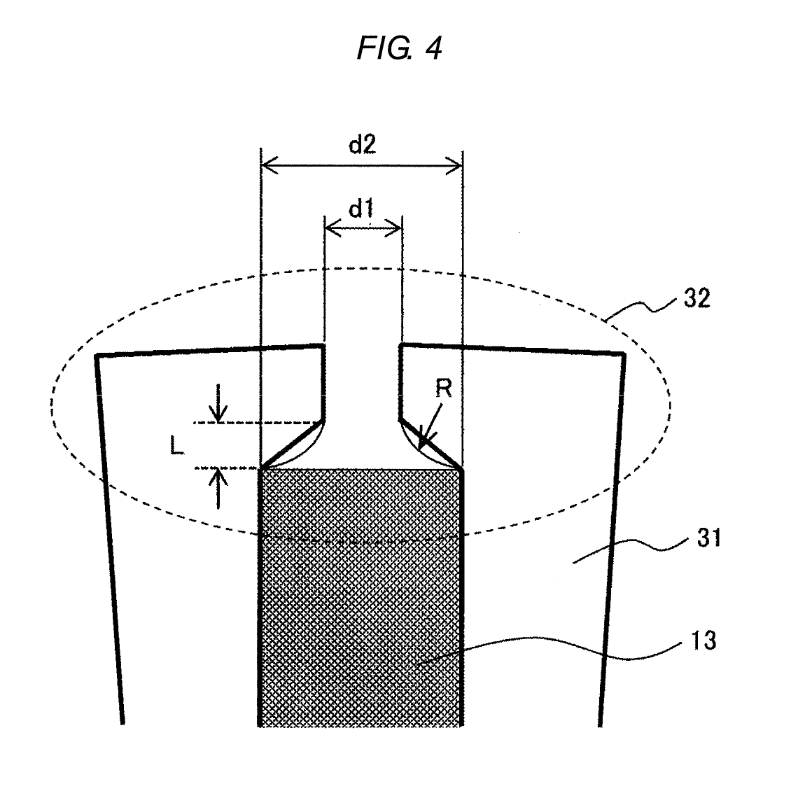

FIG. 4 illustrates a relationship between the length L and the radius of curvature R in the distal end portion 32 of the rotor tooth. In the drawing, a portion where the width d1 at the distal end portion is increased to the width d2 corresponds to the inhibiting portion, and in the related art in FIG. 13, this portion is formed of linear lines.

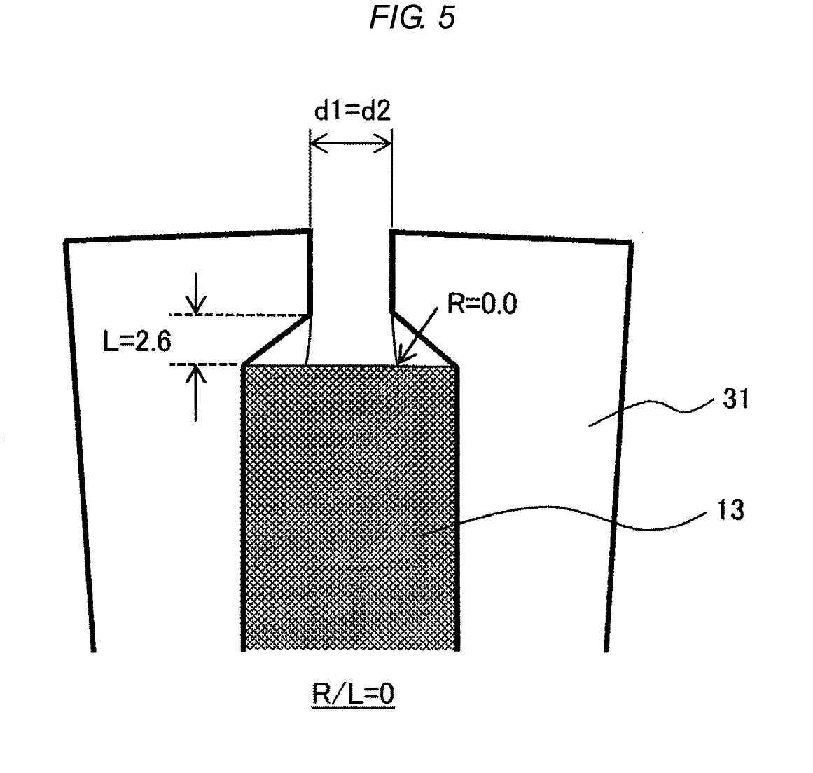

Although the ratio (R/L) of the length L and the radius of curvature R is dealt with in the invention, the shape meant by this ratio is illustrated in FIG. 5 to FIG. 8. The length L in this case is assumed to be 2.6.

FIG. 5 illustrates a case where the ratio (R/L) is 0, and hence the radius of curvature R is zero. The width d1 is not increased and is equal to the width d2. Therefore, a corner portion is formed with respect to the rotor conductor bar 13.

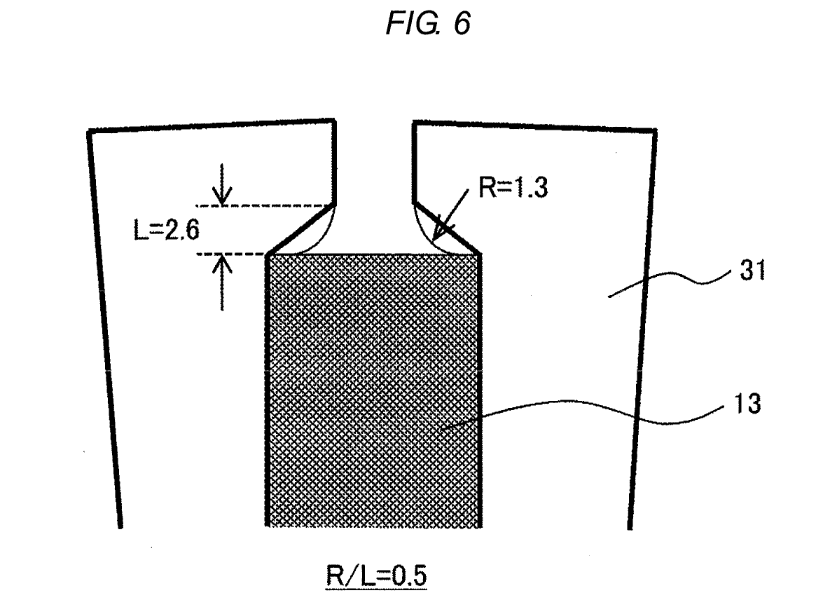

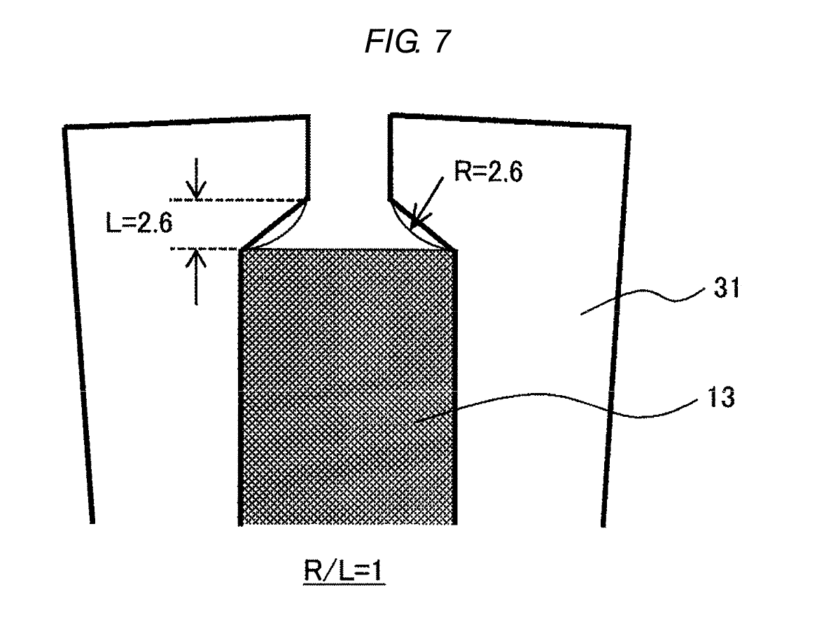

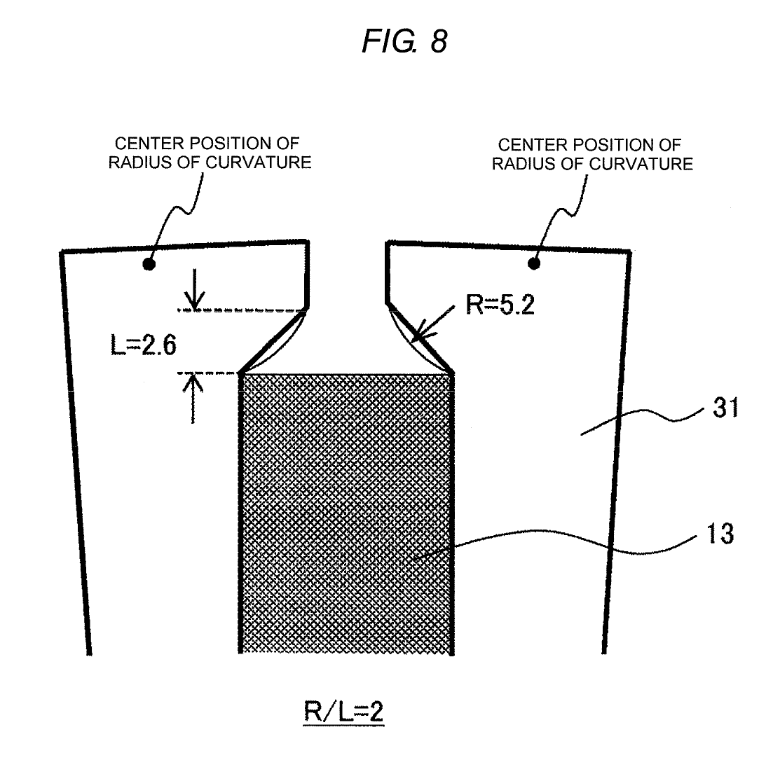

FIG. 6 illustrates a case where the ratio (R/L) is 0.5, and hence the radius of curvature R is 1.3, FIG. 7 illustrates a case where the ratio (R/L) is 1.0, and hence the radius of curvature R is 2.6, and FIG. 8 illustrates a case where the ratio (R/L) is 2.0, and hence the radius of curvature R is 5.2. According to these drawings, it is understood that the smaller the radius of curvature R, the larger the protruding extent of the projection.

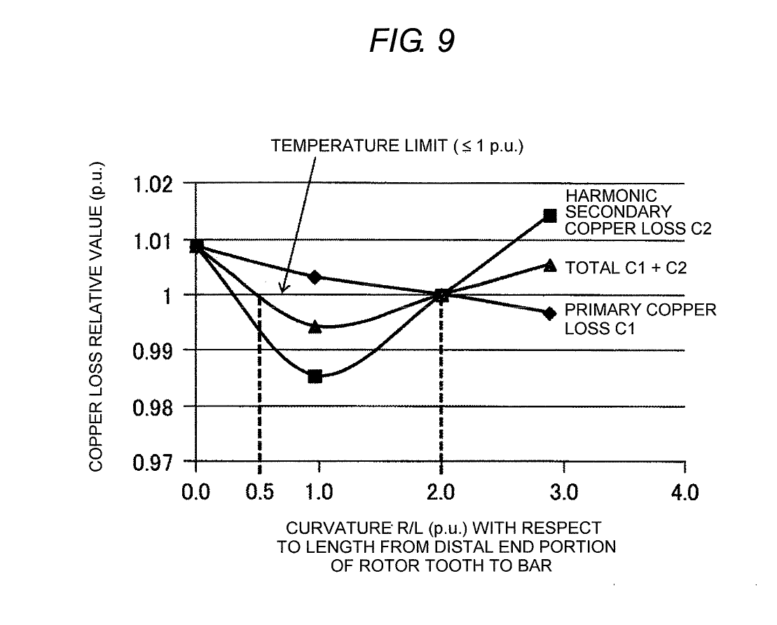

FIG. 9 illustrates a relationship between the curvature ratio (R/L) and respective copper losses with respect to the length L from the slit portion to the conductor bar of the rotor in Example 1 of the invention. In the vertical axis of the graph in FIG. 9, the relationship among the copper losses is expressed by a copper loss relative value (p, u). The copper losses include a primary copper loss C1 and a harmonic secondary copper loss C2 occurring when a current is distributed to the stator coil 5, and the total value C1+C2 of the both. When the surface area of the rotor conductor bar 13 is assumed to be constant, since the secondary copper loss is constant, the temperature limit of the induction motor 1 is determined by the total value of the primary copper loss C1 and the harmonic secondary copper loss C2, which is determined as the relative value (p, u) with reference to (1.0).

The lateral axis of the graph of FIG. 9 indicates the ratio R/L described in conjunction with FIG. 5 to FIG. 8. In this manner, the lateral axis is defined by the ratio R/L of the radius of curvature R with respect to the length L from the distal end portion of the rotor tooth to the rotor conductor bar where L is the length from the distal end portion 32 of the rotor tooth to the rotor conductor bar 13 and R is the radius of curvature of the arcuate-shaped curvature portion 61.

Here, the length L from the distal end portion 32 of the rotor tooth to the rotor conductor bar 13 is determined to be constant, and a case where the ratio R/L is 2.0 is used as a reference. In other words, the copper losses are plotted so that the values when the ratio R/L is 2.0 are unified to “1”.

According to FIG. 9, the primary copper loss C1 is reduced with increase in ratio R/L, and becomes 1.0 when the ratio R/L is 2.0. The harmonic secondary copper loss C2 takes a minimum value when the ratio R/L is 1, and increased to 1.0 or higher when the ratio R/L is 2.0 or higher. However, the closer the ratio R/L to zero, the more the harmonic secondary copper loss C2 increases, and the harmonic secondary copper loss C2 exceeds the copper loss relative value 1.0.

The reason why the respective copper losses C1 and C2 show such a trend is as follows. When the ratio R/L is set to be smaller than 2.0, the magnetic flux density of the distal end portion 32 of the rotor tooth is lowered, and the magnetic flux in interlinkage with the rotor conductor bar 13 is reduced, so that the harmonic secondary copper loss C2 is reduced. In contrast, since a leak magnetic field is increased at the distal end portion 32 of the rotor tooth, the primary copper loss C1 is increased. Consequently, the total value C1+C2 of the primary copper loss C1 and the harmonic secondary copper loss C2 indicates the minimum value when the ratio R/L is 1.0.

When R is 0, that is, when the ratio R/L is 0.0, the leak magnetic field is increased, and hence the magnetic flux flows over the surface of the rotor conductor bar and the harmonic secondary copper loss C2 is increased. Also, the total value C1+C2 of the primary copper loss C1 and the harmonic secondary copper loss C2 increases as the ratio R/L gets closer to 0.0, and when R/L 0.5 is established, the total value C1+C2 exceeds the copper loss relative value 1.0.

From the description described above, since the case where the total value of the primary copper loss C1 and the harmonic secondary copper loss C2 is 1.0 p.u, which is the temperature limit, or lower is most preferable, the ratio R/L which is the ratio of the radius of curvature with respect to the length from the distal end portion 32 of the rotor tooth to the rotor conductor bar 13 is most preferably from 0.5 to 2.0 (p. u) from the relationship illustrated in FIG. 9.

### Example 2

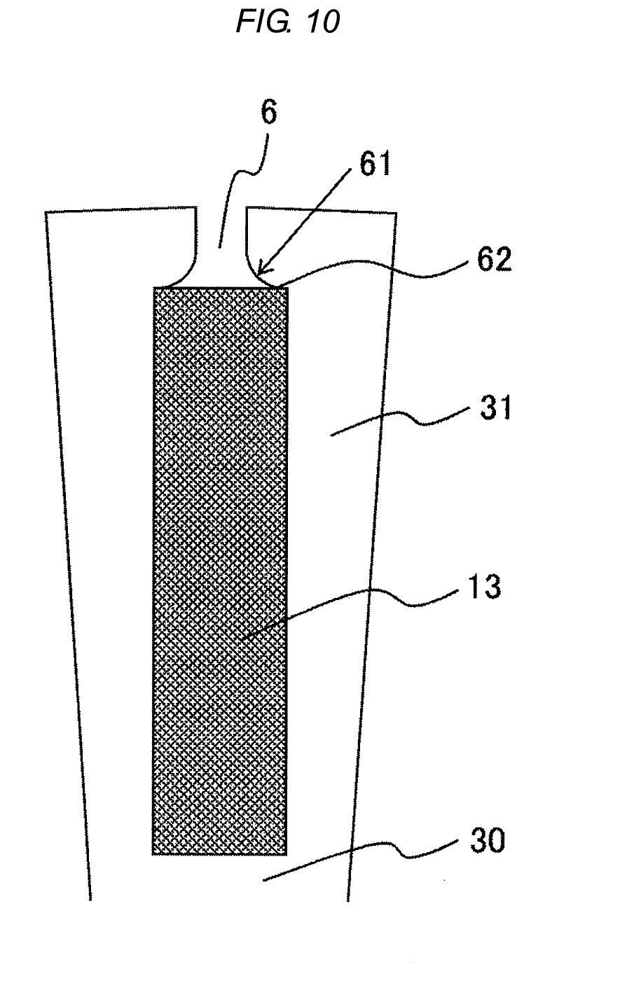

Referring now to FIG. 10, Example 2 of the invention will be described. FIG. 10 is an enlarged view of the rotor slot portion 6 of the induction motor 1 according to a mode of Example 2 of the invention. Here, illustration of the housing, the stator, and the shaft is omitted.

FIG. 10 is different from FIG. 3 in that the shape of the distal end portion 32 of the rotor tooth includes curvature portions 61, and linear portions 62 parallel to the rotor conductor bar 13 and in contact with the rotor conductor bar 13.

According to Example 2, the harmonic secondary copper loss occurring in the rotor conductor bars 13 may be reduced, and the rotor conductor bars 13 can be inhibited from being moved by the centrifugal force applied to the rotor conductor bars 13 by the rotation of the rotor 3 by the presence of the linear portions 62, whereby a high-speed operation of the induction motor 1 is enabled.

### Example 3

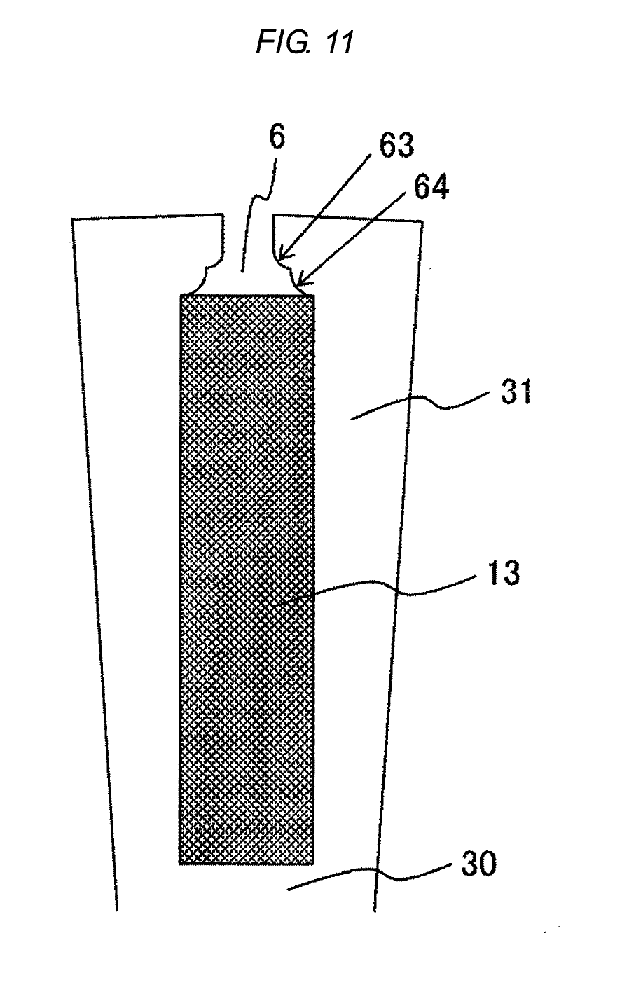

Referring now to FIG. 11, Example 3 of the invention will be described. FIG. 11 is an enlarged view of the rotor slot portion 6 of the induction motor 1 according to a mode of Example 3 of the invention. Here, illustration of the housing, the stator, and the shaft is omitted.

FIG. 11 is different from FIG. 3 in that the shape of the distal end portion 32 of the rotor tooth includes two or more of curvature portions 63 and curvature portions 64 having an arcuate shape projecting from the distal end portion 32 of the rotor tooth toward the rotor conductor bar 13.

According to Example 3, the same advantages as those in Example 1 are achieved, and hence the efficiency may be improved by reducing the harmonic secondary copper loss.

### Example 4

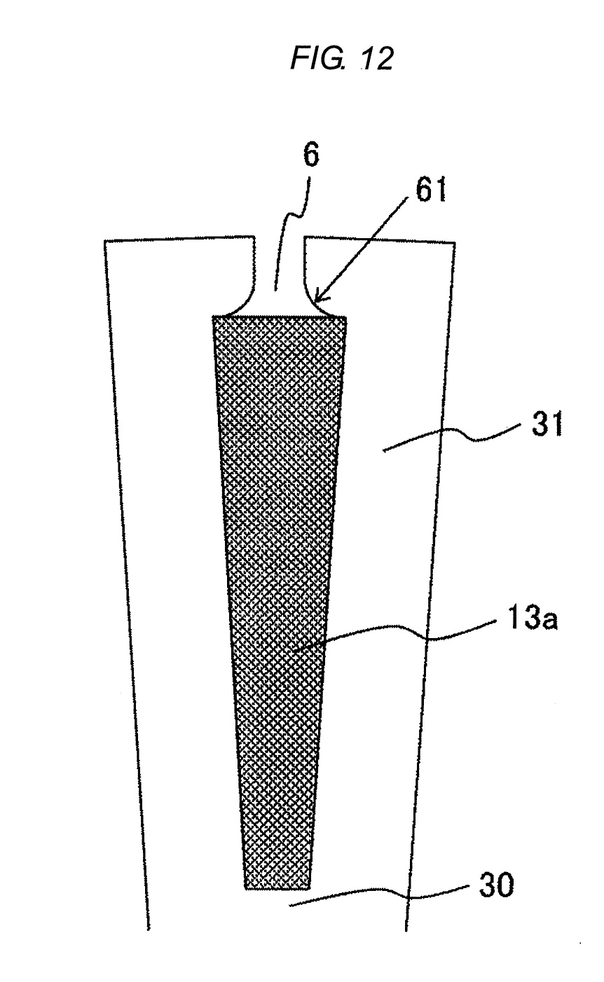

Referring now to FIG. 12, Example 4 of the invention will be described. FIG. 12 is an enlarged view of the rotor slot portion 6 of the induction motor 1 according to a mode of Example 4 of the invention. Here, in FIG. 12, illustration of the housing, the stator, and the shaft is omitted.

FIG. 12 is different from FIG. 3 in that the shape of a rotor conductor bar 13a accommodated in the rotor slots 6 has a trapezoidal shape.

According to Example 4, the harmonic secondary copper loss occurring in the rotor conductor bar 13a having a trapezoidal shape may be reduced, and the rotor conductor bar 13a can be extended toward the inner periphery thereof without reducing the width of the rotor teeth 31 on the inner peripheral side, whereby the resistant value of the rotor conductor bar 13 may be reduced and the secondary copper loss may also be reduced. Accordingly, the loss of the induction motor 1 may be reduced, and hence further increase in efficiency of the induction motor 1 is achieved.

### Example 5

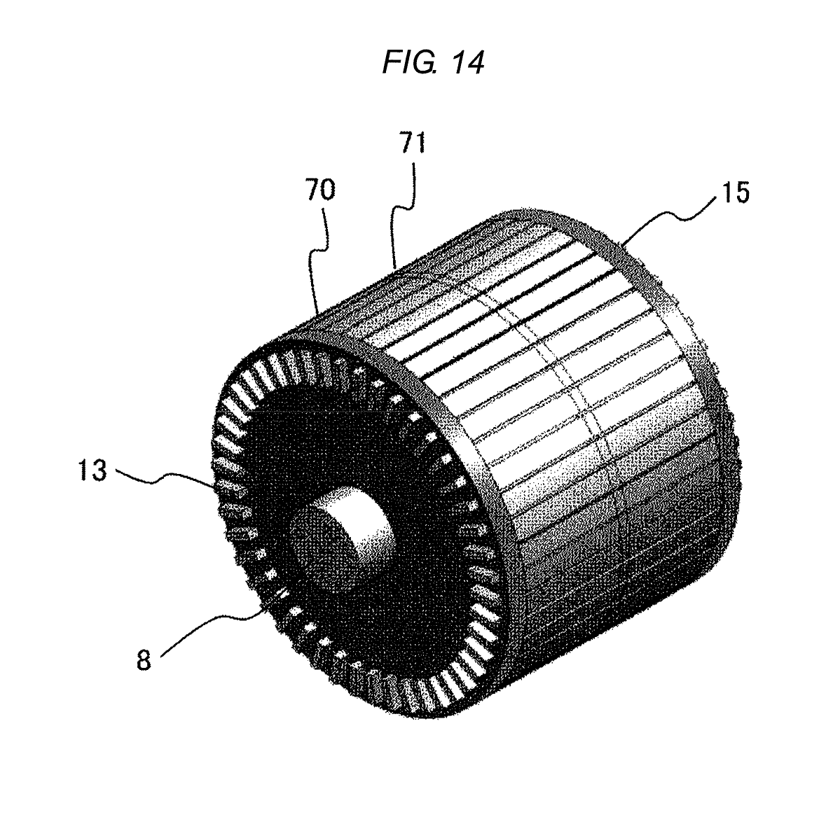

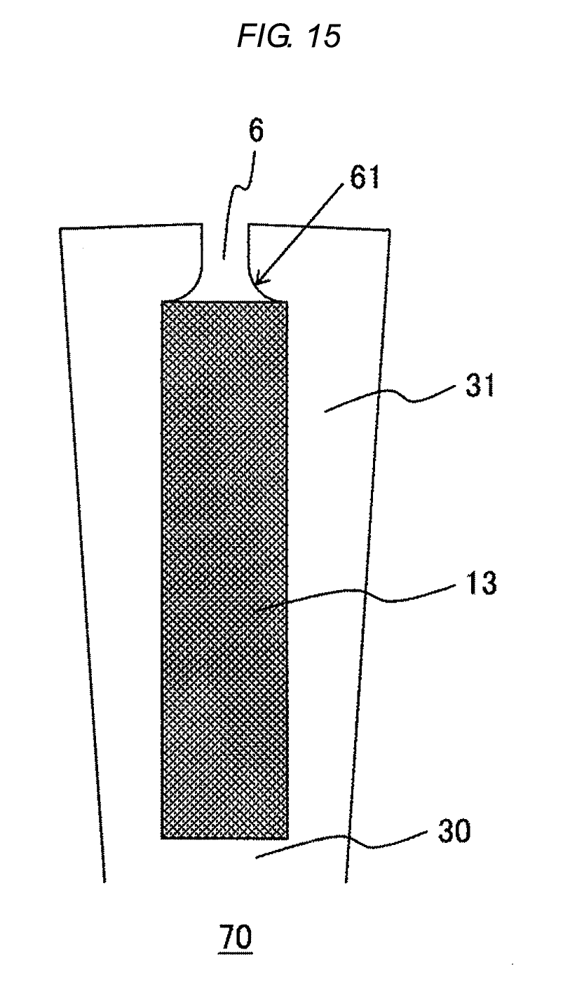

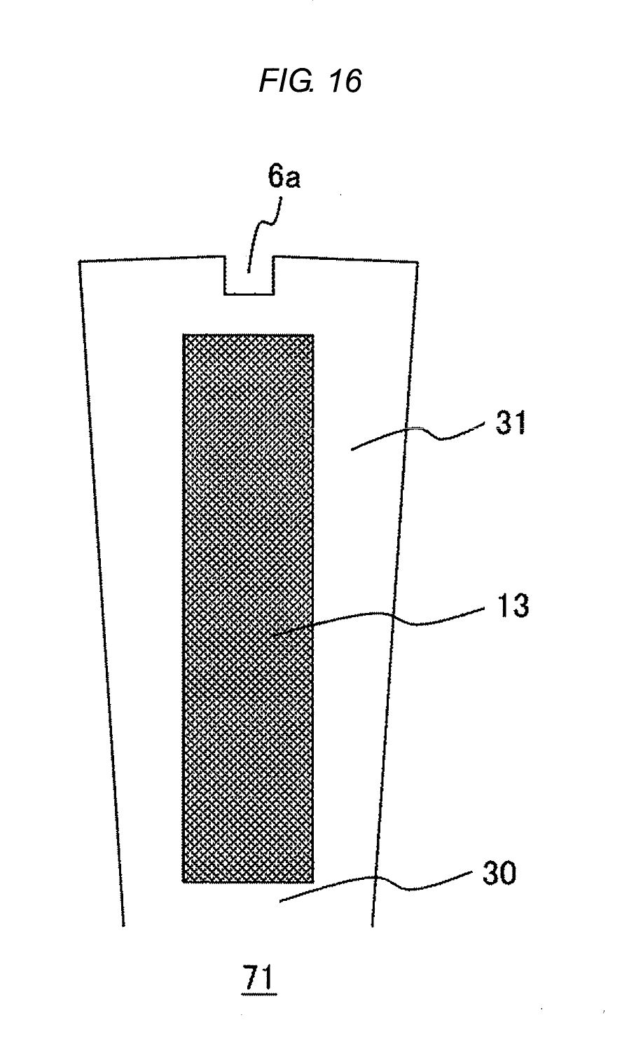

Referring now to FIG. 14, FIG. 15, and FIG. 16, Example 5 of the invention will be described. FIG. 14 is a perspective view of the induction motor 1, and FIG. 15 and FIG. 16 are enlarged views of the rotor slot portion according to a mode of Example 5 of the invention. Here, illustration of the housing and the end ring is omitted. Also, illustration the housing and the stator is omitted.

Example 5 is different from FIG. 3 in that the shape of the rotor slots 6 on a void side in FIG. 14 includes both a rotor core 70 of an open type and a rotor core 71 of a fully-closed type. In the example illustrated in FIG. 14, the end plates 15 are of the fully-closed type. However, the high-speed operation is possible even though the end plates 15 are of the open type.

FIG. 15 is an enlarged view illustrating the rotor slot portion of the open type rotor core 70, and FIG. 16 is an enlarged view illustrating the rotor slot portion of the fully-closed type rotor core 71. In FIG. 16, reference sign 6a denotes a fully-closed slot of the rotor.

According to Example 5, the harmonic secondary copper loss occurring in the rotor conductor bars 13 may be reduced, and the rotor core 71 of the fully-closed shape illustrated in FIG. 16 is provided, the rotor conductor bars 13 can be inhibited from being moved by the centrifugal force applied to the rotor conductor bars 13 by the rotation of the rotor 3, whereby the high-speed operation of the induction motor 1 is enabled.

### Example 6

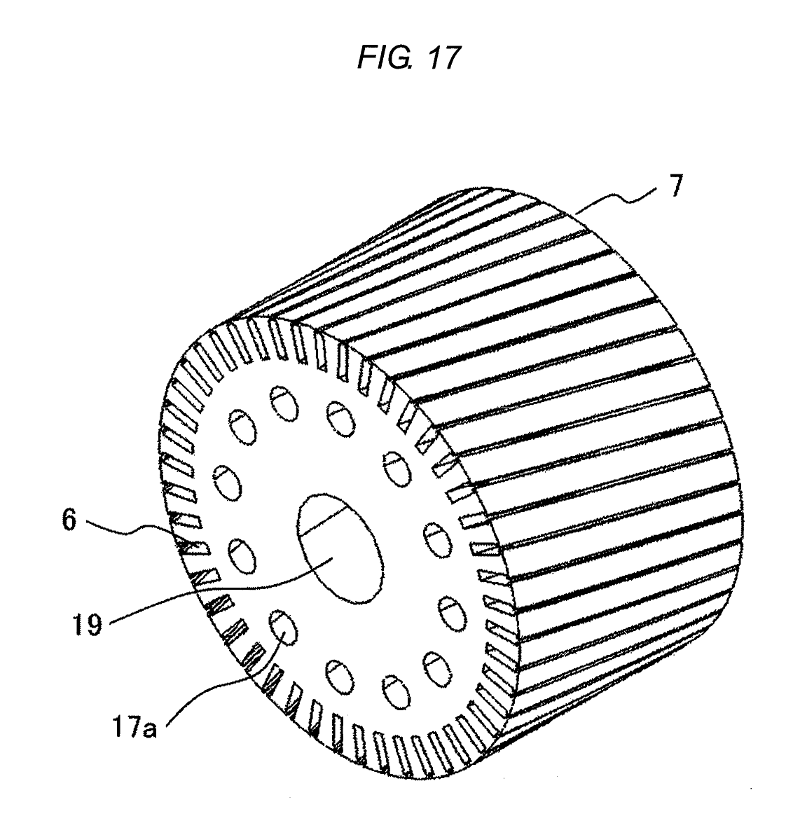

Referring now to FIG. 17, Example 6 of the invention will be described. FIG. 17 is a perspective view of the induction motor 1 according to a mode of Example 6 of the invention, and illustration of the housing, the stator, the shaft, a holding plate, the rotor conductor bar, and the end ring is omitted.

Example 6 is different from FIG. 3 in that the rotor core 7 is skewed in the circumferential direction, which is effective for reduction of the harmonic secondary copper loss as the configuration illustrated in FIG. 3.

### Example 7

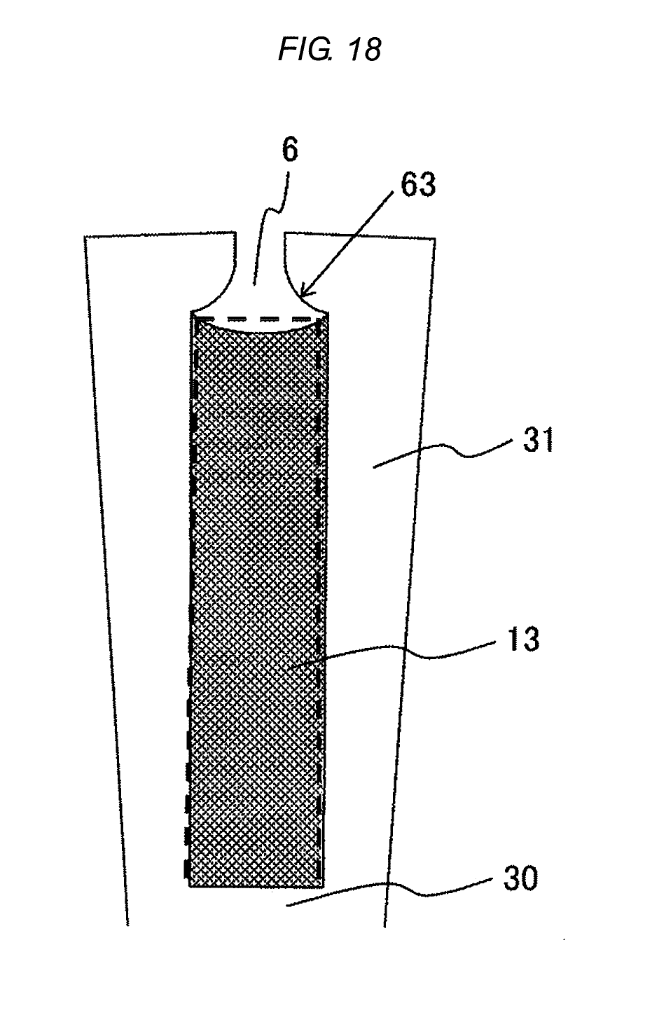

Referring now to FIG. 18, Example 7 of the invention will be described. FIG. 18 is an enlarged view of the rotor slot portion 6 of the induction motor 1 according to a mode of Example 7 of the invention. Here, illustration of the housing, the stator, and the shaft is omitted.

Example 7 is different from FIG. 3 in that the rotor conductor bar 13 accommodated in the rotor slot 6 is held by caulking from the side of the opening of the rotor slot 6.

According to Example 7, the harmonic secondary copper loss occurring in the rotor conductor bars 13 may be reduced, and the rotor conductor bars 13 are widened in the width direction of the rotor slots 6 by caulking, so that the rotor conductor bars 13 can be inhibited from being moved by the centrifugal force applied to the rotor conductor bars 13 by the rotation of the rotor 3, whereby the high-speed operation of the induction motor 1 is enabled.

### Example 8

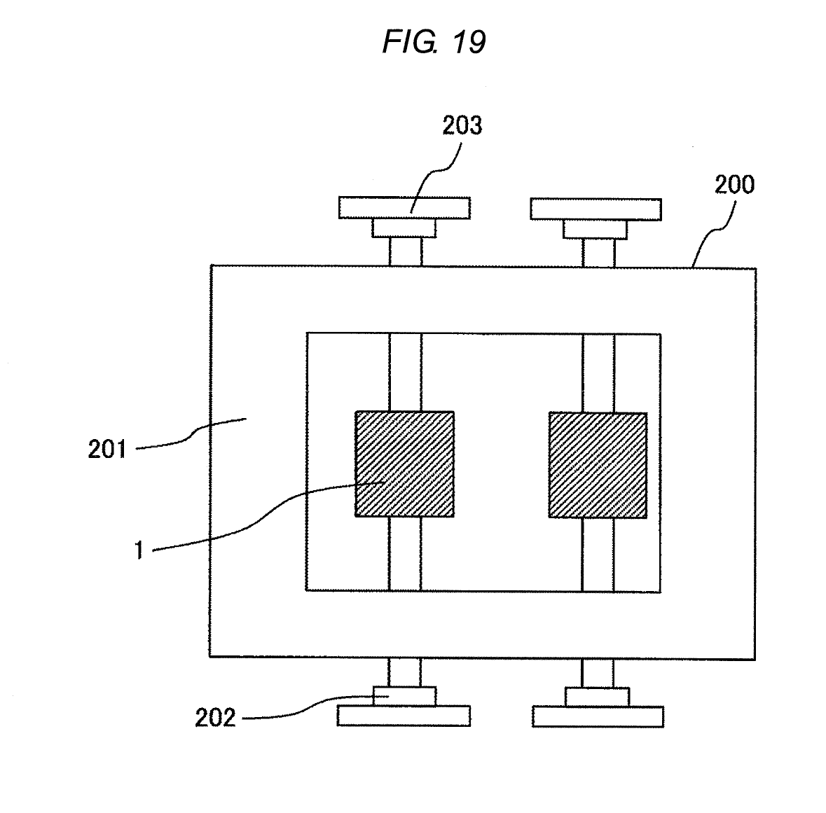

Subsequently, a railway vehicle using the induction motor according to Example 8 of the invention will be described with reference to FIG. 19. FIG. 19 is a block configuration drawing illustrating, the railway vehicle on which the induction motor according to Example 8 of the invention is mounted.

In FIG. 19, a railway vehicle 200 includes the induction motor 1, speed-up gears 202, and wheels 203 on a carriage 201, and the induction motor 1 drives the wheels 203 via the speed-up gear 202. Two of the induction motors 1 are used in the drawing, one or a plurality of the induction motors 1 may be mounted and driven.

Although the induction motor has been described as being used for driving the wheels of the railway vehicle in Examples described above, it is also possible to be used in a driving apparatus for electric construction equipment or any other driving apparatuses.

Since the loss of the induction motor may be reduced by applying to electric vehicles or railway vehicle configured to drive the rotor conductor bar and the induction motor according to the embodiments of the invention by an inverter, a highly efficient induction motor may be provided.

What is claimed is:

1. An induction motor comprising:
a stator and a rotor arranged so as to face the stator via a void, the rotor including conductor bars in a plurality of slots formed by a plurality of teeth arranged in the circumferential direction of a rotatably held rotor core,
wherein the circumferential width of distal end portions of the slots on the radially outside of the rotor core are narrowed by distal end portions of the teeth on the radially outside of the rotor core, and the teeth are each formed with a projection protruding in an arcuate shape from the distal end of the tooth on the radially outside of the rotor core toward the conductor bar in each of the slots.

2. The induction motor according to claim 1,
Wherein the ratio R/L is within a range of 0.5<R/L<2.0 where L is a circumferential length from a point of the distal end portions of the slots on the radially outside of the rotor core where the width thereof starts to be decreased until the conductor bar of the rotor, and R is a radius of curvature of the arcuate-shaped projection.

3. The induction motor according to claim 2,
Wherein the arcuate-shaped projection includes a plurality of arcuate shapes.

4. The induction motor according to claim 3,
Wherein part of the arcuate-shaped projection is in contact with the conductor bar.

5. The induction motor according to claim 4,
Wherein the rotor includes an iron core having slot openings of an open type and an iron core having slots of a fully-closed type arranged in the axial direction.

6. The induction motor according to claim 4,
Wherein the conductor bars accommodated in the rotor slots have a trapezoidal shape in cross section in the circumferential direction.

7. The induction motor according to claim 6,
Wherein the rotor core is skewed in the circumferential direction.

8. The induction motor according to claim 7,
Wherein the conductor bars are caulked from the side of the openings of the rotor slots.

9. A railway vehicle comprising:
an induction motor including a stator having a stator core on which a stator coil is wound; and
a rotor rotatably held in an inner periphery of the stator, and including a rotor core and a plurality of conductors arranged in the interior of the rotor core so as to face the stator core, and the induction motor being configured to drive wheels,
Wherein the induction motor comprises a stator and a rotor arranged so as to face the stator via a void, the rotor including conductor bars in a plurality of slots formed by a plurality of teeth arranged in the circumferential direction of a rotatably held rotor core, and
wherein the circumferential width of distal end portions of the slots on the radially outside of the rotor core are narrowed by distal end portions of the teeth on the radially outside of the rotor core, and the teeth are each formed with a projection protruding in an arcuate shape from the distal end of the tooth on the radially outside of the rotor core toward the conductor bar in each of the slots.

10. The railway vehicle according to claim 9,
Wherein the ratio R/L is within a range of 0.5<R/L<2.0 where L is a circumferential length from a point of the distal end portions of the slots on the radially outside of the rotor core where the width thereof starts to be decreased until the conductor bar of the rotor, and R is a radius of curvature of the arcuate-shaped projection.

11. The railway vehicle according to claim 10,
Wherein the arcuate-shaped projection includes a plurality of arcuate shapes.

12. The railway vehicle according to claim 11,
Wherein part of the arcuate-shaped projection is in contact with the conductor bar.

13. The railway vehicle according to claim 12,
Wherein the rotor includes an iron core having slot openings of an open type and an iron core having slots of a fully-closed type arranged in the axial direction.

14. The railway vehicle according to claim 12,
Wherein the conductor bars accommodated in the rotor slots have a trapezoidal shape in cross section in the circumferential direction.

15. The railway vehicle according to claim 14,
Wherein the rotor core is skewed in the circumferential direction.

16. The railway vehicle according to claim 15,
Wherein the conductor bars are caulked from the side of the openings of the rotor slots.
